(19) United States
(12) Patent Application Publication
(10) Pub. No.: US 2014/0066155 A1
(43) Pub. Date: Mar. 6, 2014

(54) BLACKJACK-BASED WAGERING GAME SYSTEMS AND METHODS

(71) Applicant: Frederick D. Noyes, Trenton, ME (US)

(72) Inventor: Frederick D. Noyes, Trenton, ME (US)

(21) Appl. No.: 14/012,645

(22) Filed: Aug. 28, 2013

Related U.S. Application Data
(60) Provisional application No. 61/693,935, filed on Aug. 28, 2012.

(51) Int. Cl. G07F 17/32

(52) U.S. Cl. CPC G07F 17/3293; G07F 17/3244
USPC 463/12; 273/292

(57) ABSTRACT

Systems and methods for providing, conducting and modifying an underlying wagering game involving standard playing cards in which a player hand competes against a dealer hand, comprising the steps of: providing one or more randomly ordered decks of playing cards; receiving a game wager; dealing the playing cards to form a player hand and two dealer hands according to the rules of the underlying game, wherein at least one card from one of the dealer hands is revealed to the player; comparing the player hand with a preset criteria; receiving a second wager responsive to the satisfaction of the preset criteria; resolving the outcome of the game wager and second wager based on a comparison of the respective hand values of the player hand and the second dealer hand.

### CROSS-REFERENCE TO RELATED APPLICATIONS FROM WHICH PRIORITY IS CLAIMED

This application claims the benefit of U.S. Provisional Patent Application No. 61/693,935 which was filed Aug. 28, 2012, the disclosure of which is incorporated herein by reference.

### BACKGROUND

1. Field of the Invention

The invention generally relates to systems and methods of providing, hosting, conducting and/or facilitating modified wagering games. In particular, the invention relates to systems and methods for providing, hosting, conducting and/or facilitating Blackjack-based wagering games, among other things.

2. Description of the Related Art

Many card games have been developed over the years and some are particularly adapted for gambling. Typically, such games include a dealer who deals cards and one or more players who place wagers on whether an outcome will be achieved based on the cards that the dealer deals. One example in this regard is Blackjack which is also known as Twenty-One.

The objective of Blackjack is for a wagering player to finish a round of play with a hand of playing cards with a sum of the total value of cards coming as close as possible to the value of twenty-one, without the player hand total exceeding twenty-one. The game is played by one or more players against a dealer with the player making an initial wager on a final outcome under the rules of blackjack, which remain fairly consistent throughout the world, and with only minor variations in different casinos or jurisdictions. Players' hands that are less than or equal to twenty-one, and exceed the value of the dealer's hand wins. All players' hands that have a lower sum than the dealer's hand and all hands that exceed the sum of twenty-one lose. Dealer and Player hands with the same total value (without the player first busting, result in ties (called a “push”). An initial two-card hand totaling twenty-one points is called blackjack, and in the absence of the dealer having a similar hand, automatically wins, without respect to the dealer's hand final; count and is often paid at odds greater than 1:1.

One conventional method of playing Blackjack uses one or more standard decks of playing cards (a fifty-two card deck without jokers). Each numbered card is counted according to its face value. The Jacks, Queens and Kings are worth ten (10), and Aces are worth either one (1) or eleven (11), depending on which is most beneficial to the count of the hand. A “ten” card therefore hereinafter includes any card which has a value of ten in the game of Blackjack, that is, a numbered 10 card, Jacks, Queens and Kings.

Once all the bets are made, the dealer will deal the cards to the players. The dealer will make two passes around the table starting with the player farthest to the left so that the players and the dealer have one card after the first pass and then receive a second card each after the second pass. The two cards dealt to the dealer or house includes one card face up or otherwise exposed to view, usually the second (and last) card dealt.

A player views an initial value of cards in the player's hand, views the dealer's up-card (the exposed card) and then makes decisions on drawing or not drawing further playing cards. This further drawing is done in an attempt to try and win the hand by having a higher count than the dealer's hand without busting, or allowing the dealer to bust the house hand. The player can “stand” on any count of twenty-one or less. Once the player exceeds a count of twenty-one or “busts,” the player wager is lost, whatever the ultimate point count of the dealer's hand. Usually, the dealer must hit when with a point count of less than seventeen. Normally a dealer must stand on a soft count of at least seventeen, a soft count being a hand value where an Ace is counted as a value of eleven. House rules may vary, however.

While Blackjack is a very popular game, players tend to be drawn to games that provide numerous wagering opportunities that increase player participation and excitement. Thus, there is an interest in providing variations of existing wagering games which include new wagering opportunities and acceptable odds of winning.

### SUMMARY OF THE INVENTION

The invention is generally directed to systems and methods for providing a modified wagering game involving standard playing cards in which a player hand competes against a dealer hand to determine the outcome of any wagers received, comprising the steps of: providing one or more randomly ordered decks of playing cards; receiving a game wager; dealing the playing cards to form a player hand and two dealer hands according to the rules of the underlying game, wherein at least one card from one of the dealer hands is revealed to the player; comparing the player hand with a preset criteria; receiving a second wager responsive to the satisfaction of the preset criteria; resolving the outcome of the game wager and second wager based on a comparison of the respective hand values of the player hand and the second dealer hand.

Some embodiments are directed to a method of conducting a Blackjack-based wagering game that includes the steps of: activating a shuffling device to deliver one or more randomly ordered decks of physical playing cards or otherwise providing one or more decks of randomly ordered playing cards; receiving a game wager; distributing the playing cards from the one or more randomly ordered decks of physical playing cards to form a player hand, a first dealer hand and a second dealer hand, all in an initial condition, wherein the identity of one of the playing cards of the initial first dealer hand is revealed; comparing the initial player hand with a preset criteria, wherein the preset criteria relates to the initial player hand having a Blackjack hand value that is less than or equal to a specific initial hand value; receiving a second wager if the preset criteria is satisfied; continuing the Blackjack game to form a final player hand, a final first dealer hand and a final second dealer hand; and settling the game wager and the second wager based on the outcome of the comparison of the hand values of the final player hand and the final second dealer hand if the second wager is received.

Some embodiments of the invention are also directed to a computer-aided method of conducting a Blackjack-based wagering game that includes the steps of: receiving a game wager through a communication device; randomly generating virtual representations of playing cards to form a player hand, a first dealer hand and a second dealer hand, all in an initial condition, wherein the player hand, the first dealer hand, the second dealer hand, and identity of one of the virtual representations of playing cards in the initial first dealer hand are all displayed on one or more display devices; comparing the initial player hand with a preset criteria, wherein the preset criteria relates to the initial player hand having a Blackjack hand value that is less than or equal to a specific hand value; receiving a second wager through the communication device if the preset criteria is satisfied; continuing the Blackjack game to form a final player hand, a final first dealer hand and a final second dealer hand for display on the display device; and settling the game wager and the second wager based on the outcome of the comparison of the hand values of the final player hand and the final second dealer hand if the second wager is received.

In some embodiments of the aforementioned methods, the specific initial hand value is eighteen.

In some embodiments of the aforementioned methods, the final player hand automatically loses if the hand value of the initial second dealer hand is twenty-one.

In some embodiments of the aforementioned methods, the final player hand automatically loses if the hand value of the final player hand exceeds twenty-one before comparing with the final second dealer hand.

The aforementioned methods may further include the step of settling the game wager based on a comparison of the hand values of the final player hand and the final first dealer hand.

Some embodiments of the invention are directed to a system for providing a Blackjack-based wagering game. The system may include a communication device configured for receiving a game wager and a second wager from a participating player and administering an award payout for a winning outcome to the player; a processor configured for: providing representations of playing cards to form an initial player hand, an initial first dealer hand and an initial second dealer hand; comparing the initial player hand with a preset criteria, wherein the preset criteria relates to the initial player hand having a Blackjack hand value that is less than or equal to a specific hand value; responsive to the satisfaction of the preset criteria and receiving the second wager, determining the outcome of the game wager and second wager based solely on a comparison of the hand values of the player hand in a final condition and the second dealer hand in a final condition; and a display device configured for displaying the representations of playing cards to the participating player.

The communication device may be a data input and/or data output device or a remote computer terminal, such as a home computer or mobile device with access to local or global network. The system and communication device may be configured for providing the modified wagering game to players via an online system or the Internet. The processor may also be remotely located from the display device and communication device.

In some embodiments, the communication device, processor and display device are mounted within a unitary housing. The aforementioned system may be an electronic gaming machine or electronic platform including multiple data input devices providing player positions.

### BRIEF DESCRIPTION OF THE DRAWINGS

FIG. 1 is a process flow chart depicting an exemplary game play method configured and constructed according to some embodiments of the invention.

FIG. 2 is a process flow chart depicting another exemplary game play method configured and constructed according to some embodiments of the invention.

FIG. 3 is a representation of an exemplary layout for facilitating play of game methods according to some embodiments of the invention.

FIG. 4 is a schematic diagram depicting the components of an exemplary system configured and constructed according to some embodiments of the invention.

### DETAILED DESCRIPTION

The exemplary embodiments herein relate to wagering games such as Blackjack variations in which additional side wagers other than the standard underlying game wagers are placed by players and received by the house or casino to be subsequently resolved in a secondary side wager game which is determined at least in part by some of the playing cards dealt for the underlying game.

It should be understood that the methods and steps recited herein may be partially or wholly carried out in a variety of ways, such as by a dealer physically using game elements in a casino, via an electronic gaming machine (EGM) in a gaming establishment, through a computer or portable device, such as a mobile phone, capable of communicating via the Internet, global telecommunication network or world wide web. It should further be understood that the methods and systems of the invention are described herein in connection with standard playing cards for illustrative purposes only, as the methods and systems of the invention may be used with non-standard playing cards or any other items with varying distinguishable symbols.

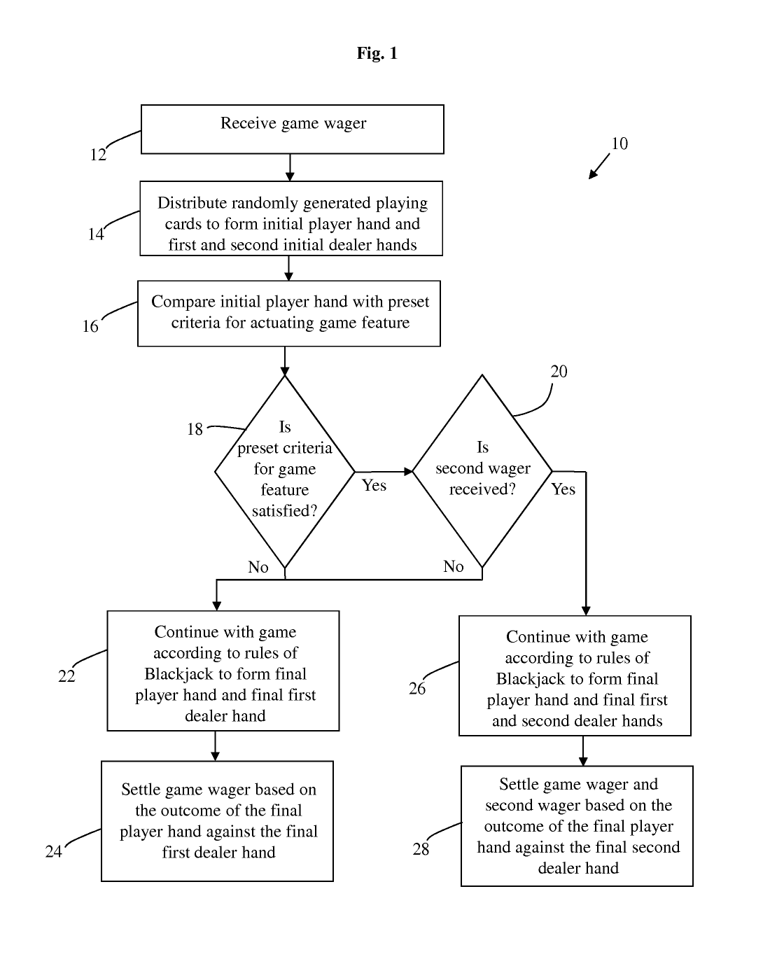

In some embodiments, the invention is directed to a method of playing an underlying wagering game, such as Blackjack, which further includes a game play feature triggered by the satisfaction of preset criteria and various steps generally referred to by the reference numeral 10 in FIG. 1.

In step 12, a game wager is received by a player interested in playing the underlying game which follows the conventional Blackjack hand scoring method for determining hand value and resolving the game outcome based on a comparison of the player hand value with the dealer hand value, with the winning hand being the one which has a value closest to or equal with twenty one but not over. However, it should be understood that the invention may be applied and adapted to other games, particularly games in which there at least two randomly generated hands of gaming elements, such as standard or non-standard playing cards, that compete with one another, such as Baccarat, Poker, or poker-based games such as Pai Gow. For purposes of illustration, the underlying wagering game of this embodiment will employ one or more decks of standard playing cards, which may be randomly ordered and shuffled by hand or machine. It should be understood that receiving a wager typically also involves a player affirmatively engaging in an action that is interpreted to place a monetary amount at risk. By receiving the wager, a gaming operator or host is also placing some monetary amount at risk, which may be determined or expressed as being equal to, or a multiple of, the monetary amount which the player is placing at risk. The affirmative action of the player to place an amount at risk may include pressing a button or physically placing a gaming chip on a designated betting area on a table game felt layout. The game operator or host may receive the wager, thus indicating acceptance thereof, through a variety of actions, which may involve illumination of betting areas on a table or other displays, or by continuing to step 14 in which randomly ordered playing cards are distributed to form the initial player hands and the two initial dealer hands as discussed herein.

In step 14, playing cards from one or more randomly-ordered decks, or in other embodiments, randomly generated virtual representations of playing cards, are dealt to form each player hand and two dealer hands. An automated shuffling device may be operatively associated with a gaming table for facilitating provision of gaming method 10 which can be operated as part of step 14 in order to provide one or more randomly-ordered deck of cards. The decks of cards may include all the standard cards or may be modified, such as by having all four ten cards removed from each deck. Modifications to the contents of the one or more decks may be made for a variety of reasons, such as to adjust the house advantage either in favor of the house or player. The hands are in an initial condition in the game of Blackjack in that the option to hit has not been provided and no additional cards have been dealt to any of the hands. The distributing of playing cards may follow a particular preset sequence and order. For example, according to the rules of conventional Blackjack, dealing cards involves a pattern in which each player receives a first card, beginning with the player to the left-most of the dealer and then proceeding to the right until all players have a first card. Once the players each have a first card, then the dealer will receive a first card, although in this embodiment the dealer will receive a first card for two distinct dealer hands. The dealer will then deal a second a card to each player following the same pattern until the dealer deals the last card to form the second card of the second initial dealer hand of the two initial dealer hands. In this embodiment, the initial player hands are dealt with the cards face-up, that is, in a manner which immediately reveals the card rank, suit and value according to the rules of Blackjack. One of the two initial dealer hands, which will also be referred to for sake of this description as being the initial first dealer hand, is dealt with one card face-up or revealed and one card face-down or hidden. The other one of the two initial dealer hands, that is, the initial second dealer hand, is dealt two cards face-down.

As shown in step 16, the initial player hand will be compared with one or more preset criterion, which is referred to herein as preset criteria to determine if a game feature is actuated. The preset criteria may relate to any one or more identifiable characteristics and/or sub-characteristics of the cards and hand, including their rank and/or suit, or value in the game. For example, the preset criteria may be an initial player hand with a score or value of greater than a specific number, within a range of possible numbers or less than a specific number. In some embodiments, the preset criteria relates to any circumstances that result in the player's odds of winning the wager received in step 12 being statistically unlikely in the underlying game, such as the initial player hand having a low value, the initial first or second dealer hand having a high value or at least the appearance of high value as can be best determined from the up card. In an example, when the game is Blackjack, the preset criteria may relate to the value of the up card in the initial first dealer hand. In another exemplary embodiment in which the underlying game is Blackjack the preset criteria may relate to the initial player hand being equal to or less than the score of eighteen according to the rules of Blackjack.

As shown in step 18, if the game feature preset criteria is satisfied, then the game feature is actuated in which the opportunity for player to optionally place a second wager becomes available.

The player has an option to place the second wager in step 20, however, it should be understood that the second wager placed by the player in step 20 must be received by the operator in the manner as described above with respect to the game wager. The second wager may be required to be the same or of different monetary value than the game wager. In some embodiments, the second wager may be a multiple of the game wager, such as from one to three times the game wager.

If the preset criteria is not satisfied in step 18 or if the second wager is not received in step 20, then the underlying game continues in step 22 according to the rules of Blackjack to form the final player hand, and if the final player hand does not bust, that is, end up with a score over twenty-one, then the game wager received in step 12 will be settled based on the outcome of the final player hand against the final first dealer hand, which will also be formed according to the rules of Blackjack, as shown in step 24.

In some embodiments, if the second wager is received in step 18, then the final player hand will compete against both the first and the second dealer hands in their respective final conditions. For example, the game wager received in step 12 may be settled based on the outcome of the final player hand against the final first dealer hand and the second wager received in step 18 may be settled based on the outcome of the same final player hand but against the final second dealer hand if the second wager is received in step 18, that is, unless the final player hand is a bust or either the first and/or second dealer hands are a natural twenty-one in their initial conditions.

In this embodiment, if the second wager is received in step 18, then as shown in step 26 the underlying game will continue according to the rules of Blackjack to form the final first and second dealer hands but the final player hand will compete against only the final second dealer hand in step 28, that is, the game wager received in step 12 and the second wager received in step 18 will both be settled based on the outcome of the final player hand against the final second dealer hand. Thus, while the initial circumstances may be such that the odds of winning for the player were relatively good or bad, but regardless, the player having knowledge of at least one card in the initial first dealer hand and their own hand value may select to compete against the unknown second dealer hand instead of the first dealer hand so long as the preset criteria is met and the second wager is received.

In this embodiment, the first and second dealer hands are put into final condition even if all players in the game have placed the second wager in step 18 so that no final player hand will be compared with the final first dealer hand to determine the outcome for settling the game and second wager in step 28. In other embodiments, the first dealer hand is ignored and not put into final condition under the circumstances where all of the final player hands will be competing against the final second dealer hand. In this embodiment, if no second wager is received from any player then only the first dealer hand will be put into final condition since no final player hands will be competing against the final second dealer hand. However, in other embodiments, the second dealer hand may be put into final form even if no player hand will be competing against it.

In some embodiments, method 10 may also include additional features such as a player hand natural, that is, an initial player hand of twenty-one, results in a payout multiple of the game wager equal to 6:5. In some embodiments, the player hand natural does not win if the first dealer hand is a natural, but rather pushes instead. Another feature may include the option for players to double down on any two card hand and after splitting, as well as allowing players to split any pair except aces to a total of four hands. Yet another feature may include the option for players to split aces but receive only one card on split aces. Still yet another feature may include the dealer being required to hit on a soft seventeen hand value according to the Blackjack scoring method.

The various illustrative embodiments of the invention may be implemented in conjunction with a physical table as a live table game utilizing physical playing cards and money or chips representative of the actual dollar value of a wager. The physical playing surface may include positions that facilitate play, such as designated hand placement areas for the player and dealer hands and designated wagering areas for receiving the game and/or second wager, which is initiated by the player placing their money or representative thereof in the designated areas. Alternatively, the methods according to the present invention may be implemented in part or whole by computer hardware devices, and presented by means of computer program code which, by way of example, when executed by a processor, causes the display of the game and conditions of the hands on a display device.

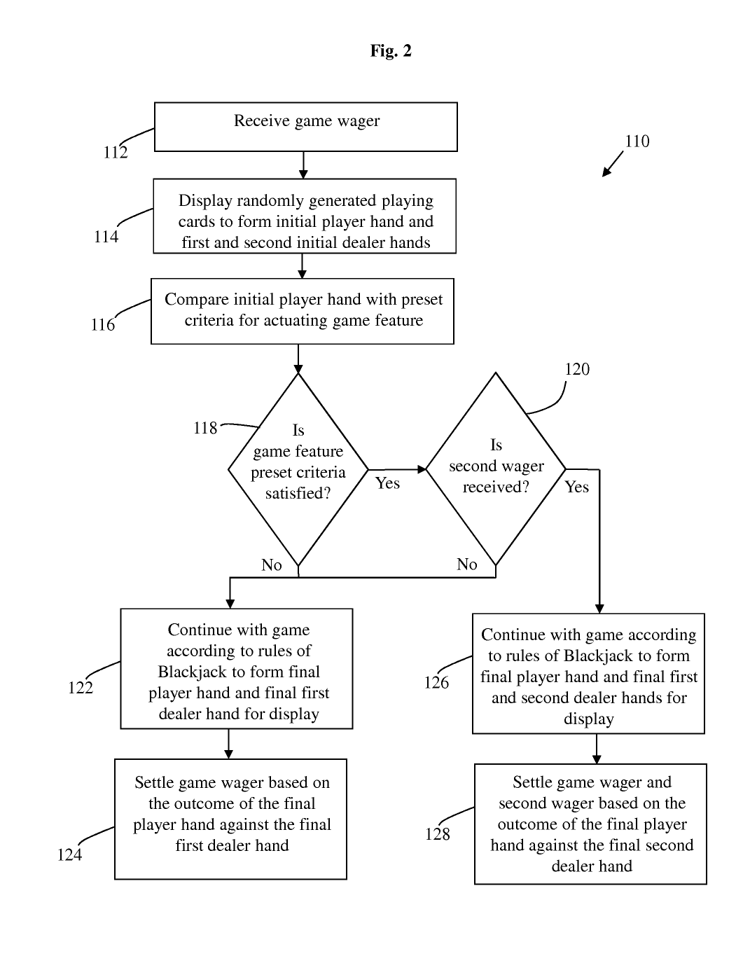

FIG. 2 illustrates an embodiment of the invention generally referred to by the numeral 110. In this embodiment, the dealing and distribution of random playing cards is facilitated by a processing device and/or random number generator in communication with a display device so that the initial and final hands are formed and displayed at least in steps 114, 122 and 126, respectively. The game wager may be received in step 112 and the second wager in step 118 may be received through a communication device or player interface. In addition, the processing device or another processing device may be involved in the process such as in comparing the initial player hand with the preset criteria in step 116.

In some embodiments, a method such as method 110 may be achieved by means of a display device in communication with a software program stored in a data storage device, database or memory, which is mounted on, in or adjacent the physical playing surface in association with which the game is played. In some embodiments, wagers may be received through a touchscreen display mounted on a physical gaming table.

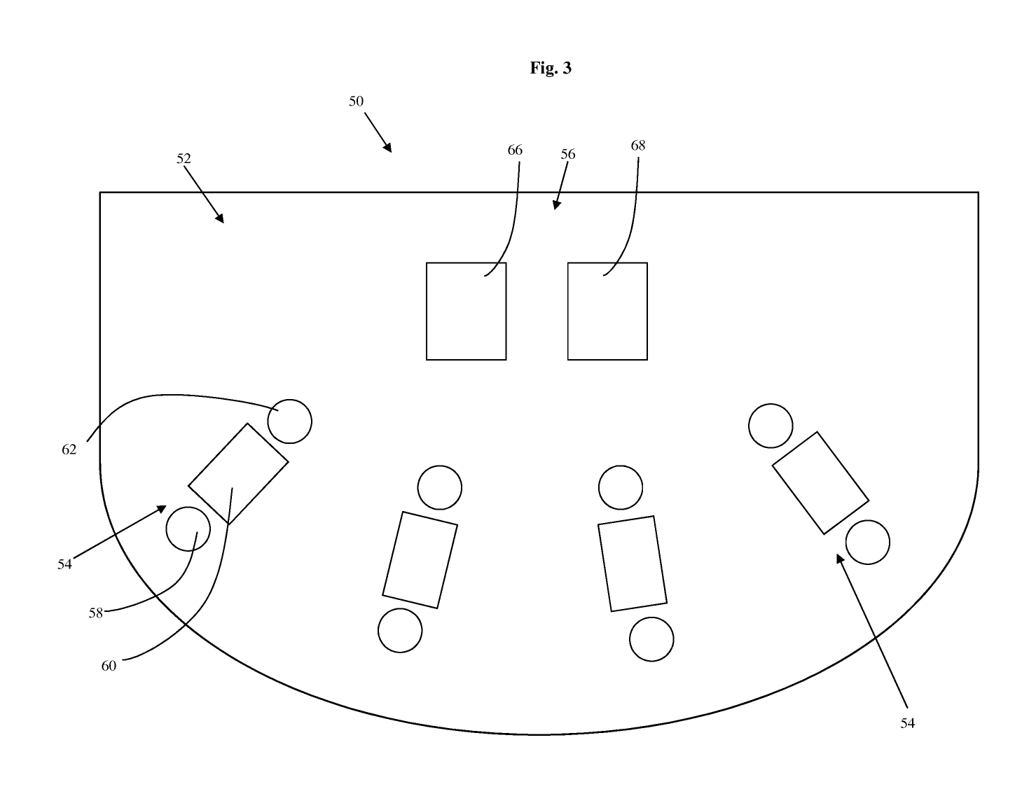

FIG. 3 illustrates an exemplary system 50 configured for operating in accordance with embodiments of the invention. System 50 includes a layout 52 for use in facilitating the presentment and display of a method of the invention such as method 10 or 110. Layout 52 may be a physical felt implemented on a gaming table or a virtual representation of a felt table display presented on a display device, as it should be understood that the methods of the invention would function as described herein if any one or more of the layout, cards, dealers or wagering chips or apparatus were physically provided or virtually represented and facilitated through a computer with appropriate hardware devices and programs. System 50 further includes multiple player positions or interfaces 54 accessible on layout 52 and a dealer position or interface 56. It should be understood that the amount of interfaces 54 may vary and the amount shown in FIG. 3 is for illustrative purposes only. In this embodiment, each player position 54 includes a game wagering position 58 for placing the game wager for receiving by the operator, a card receiving and player hand forming position 60, and a second wager placing position 62 for receiving by the operator. Dealer position 56 includes a first dealer hand position 66 and a second dealer hand position 68 for forming the respective first and second dealer hands. It should be understood that player interface 56 may further include a device for electronically receiving wagering credit, placing wagers and distributing payouts as described in this embodiment and in accordance with the invention.

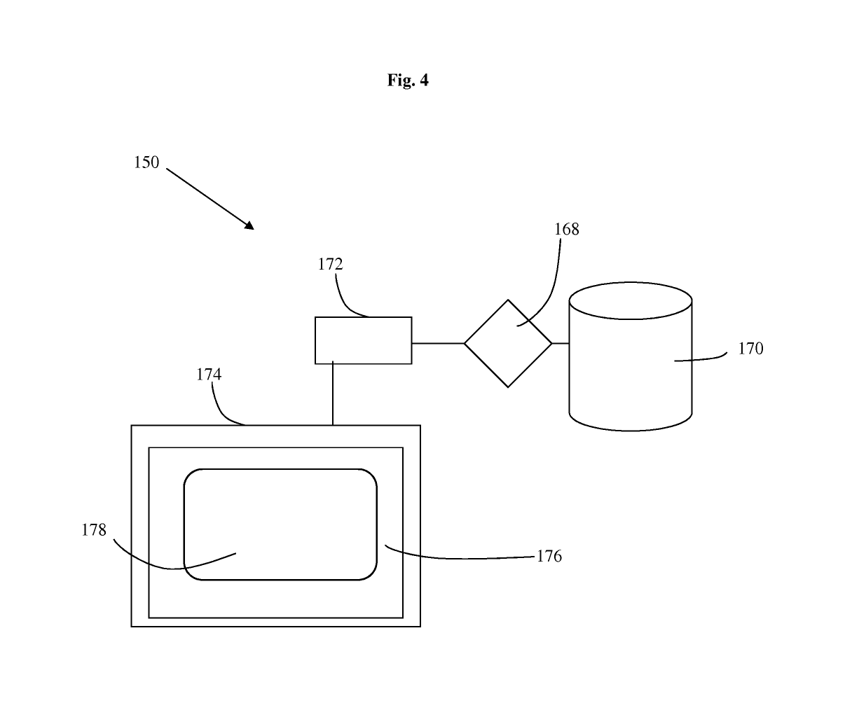

FIG. 4 illustrates an exemplary system 150 constructed in accordance with some embodiments of the invention. System 150 includes processing device 168 in communication with a database or memory device 170, communication or data input/output device 172 and a display device 174. In some embodiments, display device 174 is a touch-enabled device and includes a data input device component. Memory device 170 may include data relating to the underlying game and embodiments of the invention as described herein, such as the preset criteria. A player position 176 is displayed on display device 174 along with virtual representation of a layout and wagering area 178 for transmitting wagers in accordance with any of the embodiments herein, such as method 10 and 110. Game play is displayed on display device 174 and processing device 168 facilitates distribution of randomly generated hands of virtual cards to form the initial player hand for each player and the first and second initial dealer hands. Processing device also compares the initial player hand with the preset game feature criteria. Should the preset criteria be satisfied, the game feature will be actuated by processing device 168 and indicated on display device 174. If the second wager is received then the final player hand will be compared with the final second dealer hand by processing device 168. If the preset criteria is not satisfied or the second wager is not received then the final player hand will be compared with the final first dealer hand by processing device 168.

Those skilled in the art will readily appreciate that the methods described herein may be incorporated in systems such as those discussed above that may include various computer and network related software and hardware, such as programs, operating systems, memory storage devices, data input/output devices, data processors, servers with links to data communication systems, wireless or otherwise, and data transceiving terminals, and may be a standalone device or incorporated in another platform, such as a mobile device. The system of the invention may be provided on electronic platforms with multiple player positions. In addition, the system of the invention may be provided at least in part on a personal computing device, such as home computer, laptop or mobile computing device through an online communication connection or connection with the Internet. Those skilled in the art will further appreciate that the precise types of software and hardware used are not vital to the full implementation of the methods of the invention so long as players and operators thereof are provided with useful access thereto or the opportunity to play the game as described herein.

While exemplary systems and methods, and applications of methods of the invention, have been described herein, it should also be understood that the foregoing is only illustrative of a few particular embodiments with exemplary and/or preferred features, as well as principles of the invention, and that various modifications can be made by those skilled in the art without departing from the scope and spirit of the invention. Therefore, the described embodiments should not be considered as limiting of the scope of the invention in any way. Accordingly, the invention embraces alternatives, modifications and variations which fall within the spirit and scope of the invention as set forth in the claims and equivalents thereto.

What is claimed is:

1. A method of conducting a Blackjack-based wagering game, comprising the steps of:
a) activating a shuffling device to deliver one or more randomly ordered decks of physical playing cards;
b) receiving a game wager;
c) distributing the playing cards from the one or more randomly ordered decks of physical playing cards to form a player hand, a first dealer hand and a second dealer hand, all in an initial condition, wherein the identity of one of the playing cards of the initial first dealer hand is revealed;
d) comparing the initial player hand with a preset criteria, wherein the preset criteria relates to the initial player hand having a Blackjack hand value that is less than or equal to a specific initial hand value;
e) receiving a second wager if the preset criteria is satisfied;
f) continuing the Blackjack game to form a final player hand, a final first dealer hand and a final second dealer hand; and
g) settling the game wager and the second wager based on the outcome of the comparison of the hand values of the final player hand and the final second dealer hand if the second wager is received.

2. A method according to claim 1, wherein the specific initial hand value is eighteen.

3. A method according to claim 1, wherein the final player hand automatically loses if the hand value of the initial second dealer hand is twenty-one.

4. A method according to claim 1, wherein the final player hand automatically loses if the hand value of the final player hand exceeds twenty-one before comparing with the final second dealer hand.

5. A method according to claim 1, further comprising the step of settling the game wager based on a comparison of the hand values of the final player hand and the final first dealer hand.

6. A computer-aided method of conducting a Blackjack-based wagering game, comprising the steps of:
a) receiving a game wager through a communication device;
c) randomly generating virtual representations of playing cards to form a player hand, a first dealer hand and a second dealer hand, all in an initial condition, wherein the player hand, the first dealer hand, the second dealer hand, and identity of one of the virtual representations of playing cards in the initial first dealer hand are all displayed on one or more display devices;
d) comparing the initial player hand with a preset criteria, wherein the preset criteria relates to the initial player hand having a Blackjack hand value that is less than or equal to a specific hand value;
e) receiving a second wager through the communication device if the preset criteria is satisfied;
f) continuing the Blackjack game to form a final player hand, a final first dealer hand and a final second dealer hand for display on the display device; and
g) settling the game wager and the second wager based on the outcome of the comparison of the hand values of the final player hand and the final second dealer hand if the second wager is received.

7. A computer-aided method according to claim 6, wherein the specific initial hand value is eighteen.

8. A computer-aided method according to claim 6, wherein the final player hand automatically loses if the hand value of the initial second dealer hand is twenty-one.

9. A computer-aided method according to claim 6, wherein the final player hand automatically loses if the hand value of the final player hand exceeds twenty-one before comparing with the final second dealer hand.

10. A computer-aided method according to claim 6, further comprising the step of settling the game wager based on a comparison of the hand values of the final player hand and the final first dealer hand.

11. A system for providing a Blackjack-based wagering game, comprising:
a) a communication device configured for receiving a game wager and a second wager from a participating player and administering an award payout for a winning outcome to the player;
b) a processor configured for:
i) providing representations of playing cards to form an initial player hand, an initial first dealer hand and an initial second dealer hand;
ii) comparing the initial player hand with a preset criteria, wherein the preset criteria relates to the initial player hand having a Blackjack hand value that is less than or equal to a specific hand value;
iii) responsive to the satisfaction of the preset criteria and receiving the second wager, determining the outcome of the game wager and second wager based solely on a comparison of the hand values of the player hand in a final condition and the second dealer hand in a final condition; and
c) a display device configured for displaying the representations of playing cards to the participating player.

12. A system according to claim 11, wherein the communication device, processor and display device are mounted within a unitary housing.

13. A system according to claim 11, wherein the processor is remotely located from the display device and communication device.

14. A system according to claim 11, wherein the specific initial hand value is eighteen.
